(19) United States
(12) Patent Application Publication
(10) Pub. No.: US 2025/0224947 A1
(43) Pub. Date: Jul. 10, 2025

(54) AUTOMATIC SOFTWARE UPGRADING IN SECURE ENCLAVES FOR TENANT-SPECIFIC ENCRYPTION WORKLOADS

(71) Applicant: OKTA, INC., SAN FRANCISCO, CA (US)

(72) Inventors: Smitha PRASAD, San Jose, CA (US); Mario John VILLAPLANA, San Antonio, TX (US); Sajan Andrew ALEXANDER, Shaker Heights, OH (US); Mahesh KERALAPURA MANJUNATHA, Fremont, CA (US); Bryan Thomas STENSON, Tacoma, WA (US); Andrew Scott HAMILTON, Simi Valley, CA (US)

(21) Appl. No.: 18/405,936

(22) Filed: Jan. 5, 2024

(51) Int. Cl. G06F 8/65; G06F 8/71

(52) U.S. Cl. CPC G06F 8/65; G06F 8/71

(57) ABSTRACT

Methods, systems, devices, and computer-readable media for automatically updating software in secure enclaves are described. A secrets management system may receive an indication that an updated version of software code to be executed in an isolated execution environment, e.g., an enclave, is available for deployment. An identifier associated with the updated version of the software code may be determined. Configuration data may be updated to indicate identifiers associated with the current and updated versions of the software code. The updated configuration data may be used to update a key policy to include the identifiers of the current and updated versions of the software code. The updated key policy may be applied to one or more managed keys and may be used to update a key management application programming interface (API) to enable both the current and updated versions of the software code to access the one or more managed keys.

### FIELD OF TECHNOLOGY

The present disclosure relates generally to identity and access management, and more specifically to techniques for automatically upgrading software in secure enclaves for tenant-specific encryption workloads.

### BACKGROUND

An identity management system may be employed to manage and store various forms of user data, including usernames, passwords, email addresses, permissions, roles, group memberships, etc. The identity management system may provide authentication and access management services for applications, devices, users, and the like associated with a client organization. The identity management system may enable the client organization to manage and control access to resources, for example, by serving as a central repository that integrates with various identity sources. The identity management system may provide such services to multiple client organizations or tenants via a multi-tenant system.

In some cases, the identity management system may further provide the client organizations with a service that supports the management of the client organizations' secrets. The secrets may include non-human identities or privileged credentials. The secrets management service may employ various techniques and processes to protect and secure the client organizations' secrets, ensuring that only authorized and authenticated users, entities, applications, software code, or the like are able to access the secrets. The secrets management service may employ an isolated computing environment, such as an enclave, to be used for managing tenant secrets and each tenant that utilizes the service may have segmented and isolated access to the enclave for managing their own secrets. The enclave may provide a cryptographically attested environment for securely encrypting and decrypting tenants' secrets and the tenants may use tenant-specific keys to access their secrets in the enclave.

### SUMMARY

The described techniques relate to improved methods, systems, devices, and computer-readable media that support techniques for automatically upgrading software in secure enclaves for tenant-specific encryption workloads. For example, an identity management system may provide a service for managing secrets of one or more tenants. The secrets may be non-human identities or privileged credentials that serve as private keys used to access protected resources in a computing environment. The secrets management service may employ an isolated computing environment, such as an enclave, to be used for securely encrypting and decrypting the tenant secrets. Each tenant that utilizes the service may have isolated access to their own secrets using a tenant key associated with the tenant. The secret management service may employ software code that is used by the enclave to access the tenant keys. In some cases, the tenant keys may be maintained by a separate service, such as a key management service (KMS). In such cases, to ensure that an access request for a tenant key has originated from a valid and authorized source, e.g., a valid and authorized enclave, the software code may be verified by the KMS before being given access to the tenant keys. In some cases, when the software code is modified or updated, the KMS may be unable to verify the authenticity of the access request and the software code may be denied access to the tenant keys. In this way, access to the tenant keys may be protected from malicious actors who may, such as through a software vulnerability, attempt to access and modify the software code in order to gain access to the tenant keys. However, in some cases, the software code may need to be legitimately updated or modified, such as for a software upgrade, by an administrator of the enclave. The described techniques provide an efficient and effective method for automatically upgrading software in secure enclaves for tenant-specific encryption workloads.

A method for updating software code in a multi-tenant system by an apparatus is described. The method may include receiving an indication that an updated version of software code to be executed in an isolated execution environment is available for deployment, determining a unique identifier associated with the updated version of the software code, modifying configuration data including a first identifier associated with a current version of the software code and a second identifier associated with a previous version of the software code, where the modifying includes updating the second identifier with the first identifier and updating the first identifier with the unique identifier associated with the updated version of the software code, generating, based on the configuration data, an updated key policy, where the updated key policy includes the updated first identifier and the updated second identifier, updating a key management application programming interface (API) by applying the updated key policy to one or more managed keys, where the updated key management API enables the current version of the software code and the updated version of the software code to access the one or more managed keys, and causing deployment of the updated version of the software code to one or more nodes of the multi-tenant system.

An apparatus for updating software code in a multi-tenant system is described. The apparatus may include one or more memories storing processor executable code, and one or more processors coupled with the one or more memories. The one or more processors may individually or collectively be operable to execute the code to cause the apparatus to receive an indication that an updated version of software code to be executed in an isolated execution environment is available for deployment, determine a unique identifier associated with the updated version of the software code, modify configuration data including a first identifier associated with a current version of the software code and a second identifier associated with a previous version of the software code, where the modifying includes updating the second identifier with the first identifier and updating the first identifier with the unique identifier associated with the updated version of the software code, generate, based on the configuration data, an updated key policy, where the updated key policy includes the updated first identifier and the updated second identifier, update a key management API to apply the updated key policy to one or more managed keys, where the updated key management API enables the current version of the software code and the updated version of the software code to access the one or more managed keys, and cause deployment of the updated version of the software code to one or more nodes of the multi-tenant system.

Another apparatus for updating software code in a multi-tenant system is described. The apparatus may include means for receiving an indication that an updated version of software code to be executed in an isolated execution environment is available for deployment, means for determining a unique identifier associated with the updated version of the software code, means for modifying configuration data including a first identifier associated with a current version of the software code and a second identifier associated with a previous version of the software code, where the modifying includes updating the second identifier with the first identifier and updating the first identifier with the unique identifier associated with the updated version of the software code, means for generating, based on the configuration data, an updated key policy, where the updated key policy includes the updated first identifier and the updated second identifier, means for updating a key management API to apply the updated key policy to one or more managed keys, where the updated key management API enables the current version of the software code and the updated version of the software code to access the one or more managed keys, and means for causing deployment of the updated version of the software code to one or more nodes of the multi-tenant system.

A non-transitory computer-readable medium storing code for updating software code in a multi-tenant system is described. The code may include instructions executable by one or more processors to receive an indication that an updated version of software code to be executed in an isolated execution environment is available for deployment, determine a unique identifier associated with the updated version of the software code, modify configuration data including a first identifier associated with a current version of the software code and a second identifier associated with a previous version of the software code, where the modifying includes updating the second identifier with the first identifier and updating the first identifier with the unique identifier associated with the updated version of the software code, generate, based on the configuration data, an updated key policy, where the updated key policy includes the updated first identifier and the updated second identifier, update a key management API to apply the updated key policy to one or more managed keys, where the updated key management API enables the current version of the software code and the updated version of the software code to access the one or more managed keys, and cause deployment of the updated version of the software code to one or more nodes of the multi-tenant system.

In some examples of the method, apparatus, and non-transitory computer-readable medium described herein, the unique identifier associated with the updated version of the software code includes a hash value associated with the isolated execution environment.

In some examples of the method, apparatus, and non-transitory computer-readable medium described herein, the hash value includes a hash of an image file of the isolated execution environment.

In some examples of the method, apparatus, and non-transitory computer-readable medium described herein, the isolated execution environment includes a virtual machine and the virtual machine includes one or more of a kernel, a central processing unit (CPU), and memory.

In some examples of the method, apparatus, and non-transitory computer-readable medium described herein, updating the key management API may include operations, features, means, or instructions for determining the one or more managed keys based on identifying, from among a set of multiple managed keys, at least one managed key associated with the multi-tenant system.

In some examples of the method, apparatus, and non-transitory computer-readable medium described herein, the first identifier associated with the current version of the software code includes a first hash value associated with a first isolated execution environment associated with the current version of the software code and the second identifier associated with the previous version of the software code includes a second hash value associated with a second isolated execution environment associated with the previous version of the software code.

In some examples of the method, apparatus, and non-transitory computer-readable medium described herein, each of the one or more managed keys may be associated with a different tenant associated with the multi-tenant system.

### BRIEF DESCRIPTION OF THE DRAWINGS

FIG. 1 illustrates an example of a computing system that supports automatic software upgrading in secure enclaves for tenant-specific encryption workloads in accordance with aspects of the present disclosure.

FIG. 2 shows an example of a system architecture that supports automatic software upgrading in secure enclaves for tenant-specific encryption workloads in accordance with aspects of the present disclosure.

FIG. 3 shows a block diagram of an apparatus that supports automatic software upgrading in secure enclaves for tenant-specific encryption workloads in accordance with aspects of the present disclosure.

FIG. 4 shows a block diagram of a software module that supports automatic software upgrading in secure enclaves for tenant-specific encryption workloads in accordance with aspects of the present disclosure.

FIG. 5 shows a diagram of a system including a device that supports automatic software upgrading in secure enclaves for tenant-specific encryption workloads in accordance with aspects of the present disclosure.

FIG. 6 shows a flowchart illustrating methods that support automatic software upgrading in secure enclaves for tenant-specific encryption workloads in accordance with aspects of the present disclosure.

### DETAILED DESCRIPTION

Cloud computing provides for the delivery of computing services or resources over the Internet. These services and resources may include software applications, data storage, databases, servers, virtual machines, operating systems, analytics, computing environments or platforms, authentication services, etc. Some organizations may use cloud computing to increase performance, manage computing and operating costs, provide for on-demand scalability of computing resources, improve reliability, and many other reasons. However, the use of cloud computing may present certain security vulnerabilities. As such, in order to ensure the security of an organization's cloud resources, and in some cases the organization's on-premises resources as well, the organization may use one or more tools to control access to the organization's resources (e.g., control what resources particular users are permitted to access, and what the users can do with the resources that they are permitted to access).

For example, when a user of an organization (e.g., an employee of the organization) wishes to access the organization's resources, the user may be requested to log into an account associated with the organization. The user may provide user credentials, such as a combination of a username and a password or other information. The system may use the user credentials as authentication information to verify an identity of the user. Once authenticated, the system may determine whether the user has been granted permission or privileges to access the requested resources.

In some cases, to alleviate a burden on an organization, the organization may employ a service provider, such as an identity management service provider, to provide identity and access management services on behalf of the organization. In such cases, the identity management service provider may provide the identity and access management service to the organization as well as to other organizations. The multiple organizations may be clients of the identity management service provider and may be referred to as client organizations or tenants. The identity management service provider may maintain an identity management system to manage the identities and access privileges of the users of the different client organizations on behalf of those client organizations.

In some cases, the identity management system may additionally provide, to one or more of the tenants, a service that supports the management of the tenants' secrets. The secrets may include non-human identities or privileged credentials. For instance, the secrets may include API keys, passwords (e.g., user or system-to-system passwords), private encryption keys, digital certificates, or the like. The secrets management service may employ various techniques and processes to protect and secure the tenants' secrets, ensuring that only authorized and authenticated users, entities, applications, software code, or the like are able to access the secrets. For instance, in some cases, the secrets management service may employ an isolated computing environment, such as an enclave (e.g., AMAZON WEB SERVICES (AWS) NITRO ENCLAVES®), used for securely encrypting and decrypting the tenant secrets and each tenant that utilizes the service may have isolated access to the enclave for encrypting and decrypting their own secrets. Each tenants' secrets may be accessed via a unique tenant key assigned to the particular tenant. The tenant key may be used to encrypt plaintext versions of secrets for securely maintaining the secrets and then to later decrypt the encrypted versions of the secrets. For instance, when a customer of a tenant is authenticated via the identity management system, the identity management system may employ a secrets service API to access the secrets management service. The secrets management service may service the customer's request to access a secret, such as by accessing and utilizing the tenant's key to perform encryption and decryption operations on data related to the secret.

The secret management service may employ software code that may be used by the enclave to access the tenant keys. For instance, the tenant keys may be maintained by a separate service, such as a KMS (e.g., AWS® key management service), and the enclave software code may be used to create tenant keys and to access the tenant keys by making calls to a key management API that interfaces with KMS. The key management API may not provide the enclave access to the KMS if the key management API is unable to attest or verify that the access calls originated from a valid enclave. Accordingly, the access call to the API may include information that may be used by the key management API to determine an identity of a source from which the access call originates. For instance, the access call may include a signed attestation document or other certificate, that includes information that uniquely identifies the source of the access call, such as unique information identifying the particular enclave from which the access call originated.

In response, to the access call, the key management API may access a key policy which may be associated with a requested tenant key. In some cases, the key policy may be associated with more than one tenant key. The key policy may include information indicating who has permission to access the tenant key and how the tenant key may be used. The key management API may compare the information in the signed attestation document with the information in the key policy, such as compare the information in the attestation document uniquely identifying the enclave to the information in the key policy, to determine whether the requesting enclave is valid and authorized to access the tenant key. If the information matches, the API may access the tenant key from the KMS and return the tenant key to the requesting enclave. The tenant key may then be used to decrypt the encrypted secrets.

In the case where a malicious actor modifies the enclave software code and uses the modified enclave software code in an attempt to make an access call to access the tenant keys, the key management API might prevent the malicious enclave software code from accessing tenant keys. This is because when the enclave software code is modified, new information that uniquely identifies the updated enclave may be generated. This updated unique identification information may not be included in the key policy information used by the key management API and, therefore, the key management API might not recognize an access call made using the modified enclave software code as originating from a valid enclave. In this case, the access request may be denied.

However, in some cases, the enclave software code may legitimately need to be updated or modified, such as for a software upgrade. In such cases, in order for the new version of the enclave software code to be used to access the tenant keys via the key management API, the key policies associated with the tenant keys used by the enclave may also need to be updated. That is, the corresponding key policies may need to be updated to indicate the information that uniquely identifies the updated enclave associated with the updated version of the enclave software code. With the updated identifying information being included in the key policies, when a call is made by the updated enclave software code to access the KMS keys, the key management API may recognize the source of the access call, e.g., the updated enclave, as valid and authorized to access the tenant keys, and the tenant keys may be provided to the updated enclave.

In cases where an identity management system is providing the secret management service to multiple tenants, updating the key policies of multiple tenants may be cumbersome. For instance, updating the key policies of each of the multiple tenants individually may cause an unacceptable amount of downtime and may prevent tenants from being able to successfully access critical applications and data. Further, in some cases it may be necessary for both the current version of the enclave software code and the new or updated version of the enclave software code to be able to access the tenant keys, at least for some predetermined period of time to allow for a seamless transition from the current to the new enclave software code.

The described techniques provide an efficient and effective method for automatically upgrading software in secure enclaves by ensuring that both current and new versions of enclave software code may access tenant keys for at least a predetermined period of time. The described techniques reduce production downtime while ensuring the secure maintenance of tenant secrets.

Aspects of the disclosure are initially described in the context of a computing system. Aspects of the disclosure are further illustrated by and described with reference to various diagrams and flowcharts that relate to automatically upgrading software in secure enclaves for tenant-specific encryption workloads.

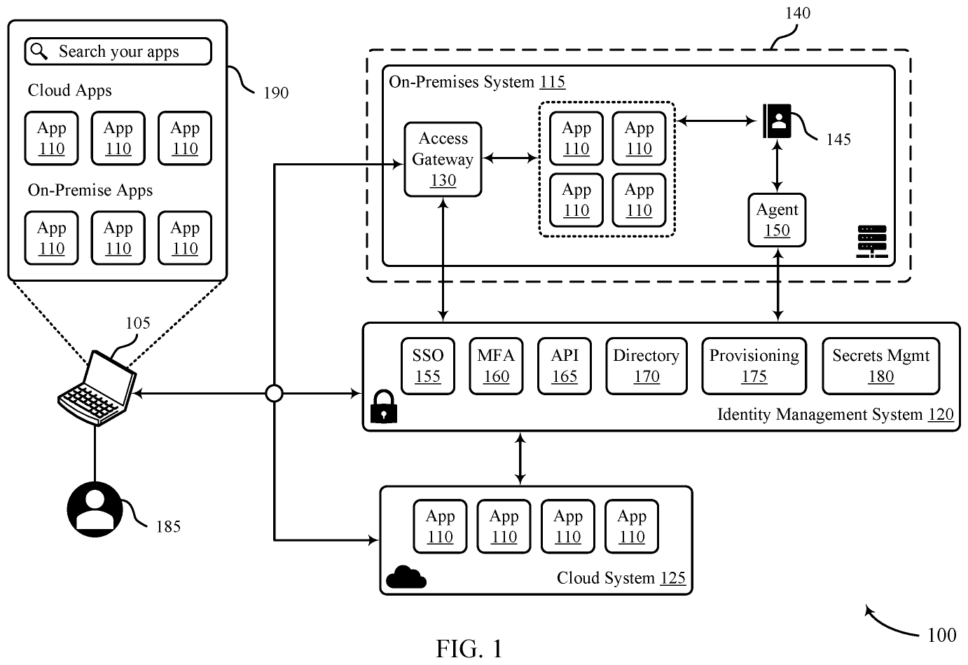

FIG. 1 illustrates an example of a computing system 100 that supports automatic software upgrading in secure enclaves for tenant-specific encryption workloads in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization, in some cases referred to as a tenant, owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which may be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include AMAZON WEB SERVICES (AWS)®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an API service 165, a directory management service 170, a provisioning service 175, or secrets management service 180 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, the provisioning service 175, and/or the secrets management service 180 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 may secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 may be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

The secrets management service 180 of the identity management system 120 may support the management and security of secrets of a client organization, e.g., a tenant. The secrets management service 180 may ensure that only authorized and authenticated users, entities, applications, software code, or the like are able to access the secrets. The secrets may include non-human identities or privileged credentials, such as API keys, passwords (e.g., user or system-to-system passwords), private encryption keys, digital certificates, or the like. The secrets management service 180 may employ various techniques and processes to protect and secure the tenants' secrets. For instance, in some cases, the secrets management service 180 may employ an isolated computing environment, such as an enclave (e.g., AWS NITRO ENCLAVES®), to be used for securely encrypting and decrypting the tenant secrets, and each tenant that utilizes the service may have isolated access to the enclave for decrypting and encrypting their own secrets. The secrets may be accessed via a unique tenant key assigned to the particular tenant associated with the secrets. The tenant key may be used to encrypt plaintext versions of the secrets and then to later decrypt the encrypted versions of the secrets. The secrets management service 180 may employ software code that is used by the enclave to access the tenant keys. In accordance with aspects described herein, in some cases, the secrets management service 180 may employ a process to efficiently and automatically upgrade software code, such as enclave software code, so as to minimize downtime when transitioning from a current version of software code to an upgraded version of the software code.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

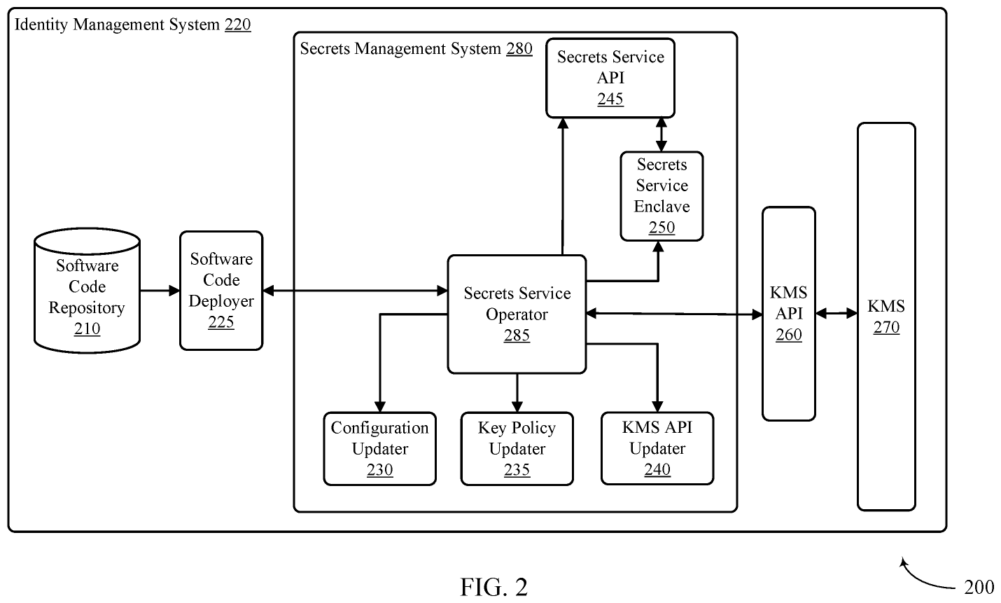

FIG. 2 shows an example of a system architecture 200 that supports automatic software upgrading in secure enclaves for tenant-specific encryption workloads in an identity management system 220 in accordance with aspects of the present disclosure. The identity management system 220 may include a software code repository 210, a software code deployer 225, a secrets management system 280, a key management API 260, and a KMS 270.

The secrets management system 280 may include a configuration updater 230, a key policy updater 235, a KMS API updater 240, a secrets service API 245, a secrets service enclave 250, and a secrets service operator 285. In some cases, the secrets management system 280 may include additional or different components. The secrets management system 280 may be used to by the identity management system 220 to provide a service that supports the management of secrets for one or more tenants of the identity management system 220. The secrets may include non-human identities or privileged credentials. For instance, the secrets may include API keys, passwords (e.g., user or system-to-system passwords), private encryption keys, digital certificates, or the like. The secrets management service may employ various techniques and processes to protect and secure the tenants' secrets, ensuring that only authorized and authenticated users, entities, applications, software code, or the like are able to access the secrets. The secrets management service may employ a secrets service enclave 250 (e.g., AMAZON WEB SERVICES (AWS) NITRO ENCLAVES®) for managing access to the tenant secrets.

The secrets service enclave 250 may be an isolated computing environment implemented on one or more virtual machines. The secrets service enclave 250 may include a kernel, as well as memory and CPUs partitioned from a parent instance of a virtual machine and allocated to the secrets service enclave 250. The secrets service enclave 250 may have no persistent storage or external network connectivity and may provide a hardened environment for protecting sensitive data and applications, such as tenant secrets. The secrets service enclave 250 may be created by an administrator of the parent instance using an image file that may include various libraries, applications, software code, and an operating system to be booted into the secrets service enclave 250. Each tenant that utilizes the secrets management system 280 may have isolated access to the secret service enclave 250 for encrypting and decrypting their own secrets. The tenants may access their secrets using a unique tenant key (in some cases referred to as a managed key) assigned to the particular tenant. The managed key may be used to encrypt plaintext versions of the secrets and then to later decrypt the encrypted versions of the secrets for processing. The secret service enclave 250 may be secured via attestation, which may be used to verify the identity of the secrets service enclave 250 before access to managed keys may be provided.

The secrets management system 280 may include a secrets service operator 285 that controls or interacts with one or more functions, operations, or components of the secrets management system 280. For instance, the secrets service operator 285 may control or interact with the software code deployer 225, the configuration updater 230, the key policy updater 235, the KMS API updater 240, and the secrets service API 245, the secrets service enclave 250, and the KMS API 260. In some cases, the secrets service operator 285 may control or interact with additional or different components. The secrets service operator 285 may control and interact with the various components in support of managing the deployment of software code employed by the secrets service enclave 250. The software code may be code used by the secrets service enclave 250 to access the managed keys used to encrypt and decrypt tenant secrets in the secrets service enclave 250.

The identity management system 220 may access the secrets management system 280 and the secrets service enclave 250 via the secrets service API 245. The secrets service API 245 may reside on the parent instance of the secrets service enclave 250 and may be used to access and store encrypted tenant secrets. For instance, when a customer of a tenant is authenticated via the identity management system 220, the identity management system 220 may utilize the secrets service API 245 to access the secrets management service provide by the secrets management system 280. The secrets management system 280 may service the customer's request to access a secret, such as by accessing and utilizing the tenant's managed key to perform encryption and decryption operations in the secrets service enclave 250 on data related to the secret.

In some instances, the managed keys may be maintained by a separate service, such as a KMS 270 (e.g., AWS® key management service), and the enclave software code may be used to access the managed keys by making a call to the key management API 260 that interfaces with the KMS 270. Before providing the secrets service enclave 250 with access to the KMS 270, the key management API 260 may first verify that the access call originated from a valid secrets service enclave 250. Accordingly, the access call to the key management API 260 may include information that may be used by the key management API 260 to verify an identity of a source from which the access call originated. For instance, the access call may include a signed attestation document or other certificate, that may include information that uniquely identifies the source of the access call, such as unique information identifying the secrets service enclave 250 from which the access call originated. The secrets service enclave 250 may be associated with a number of hashes or platform configuration registers (PCRs) that are unique to the secrets service enclave 250. One or more of these hashes may be included in the attestation document to uniquely identify the secrets service enclave 250. For example, the attestation document may include a hash (e.g., PCR0) of the image file used to create the secrets service enclave 250.

In response to an access call, the key management API 260 may access a key policy which may be associated with a requested managed key. The key policy may include rules and other information indicating who or what (e.g., applications, software code, systems, etc.) has permission to access a particular managed key and how the managed key may be used by the authorized entity. In some cases, the key policy may be associated with more than one managed key. For example, in some cases, the identity management system 220 may utilize the same rules to provide access to managed keys across multiple tenants. The key management API 260 may compare the information in the signed attestation document with corresponding information in the key policy to determine whether to grant access to the requesting entity. For instance, the key management API 260 may compare the information in the attestation document uniquely identifying the secrets service enclave 250, such as the hash value (PCR0) to corresponding information in the key policy, to determine whether the secrets service enclave 250 is valid and authorized to access the managed key. If the information matches, the key management API 260 may retrieve the requested managed key from the KMS and return the managed key to the secrets service enclave 250. The managed key may then be used to decrypt the encrypted secrets in the secrets service enclave 250. If the information uniquely identifying the secrets service enclave 250 does not match information in the key policy the key management API 260 may deny the secrets service enclave 250 access to the requested managed key.

In some cases, when the secrets service enclave 250 or its underlying software code needs to be modified or upgraded, an administrator may need to create a new version of the secrets service enclave 250. The new version of the secrets service enclave 250 may be created using a new image file and, as a result, may have new information that uniquely identifies the new version of the secrets service enclave 250. To allow the new version of the secrets service enclave 250 to make calls to the key management API 260 to access the managed keys, one or more key policies may also need to be modified to include the unique identification information for the new version of the secrets service enclave 250. Further, the updated key policy may then need to be applied to or associated with each of the various managed keys associated with tenants that utilize the secrets service enclave 250. As a result, there may be a period of time while such modifications are being made to effectuate the transition from the current to a new secrets service enclave 250, that tenants and their associated applications might not have access to their secrets. This may create a poor user experience and may impact the tenants' ability to perform critical processes or functions. Accordingly, it may be beneficial to maintain an environment in which both the current and the new versions of the secrets service enclave 250 may be able to access the managed keys via the key management API 260 for some overlapping period of time to ensure a seamless transition for tenants.

In accordance with aspects of this disclosure, the secrets service operator 285 may interact or communicate with the software code deployer 225 to detect when a new or updated version of software code for the secrets service enclave 250 is ready for deployment. For instance, the software code deployer 225 may monitor a software code repository 210 for new or updated versions of enclave software code and may provide an indication to the secrets service operator 285 when a new or updated version of the enclave software code is available for deployment. In some cases, the software code deployer 225 may retrieve or obtain the updated version of the enclave software code and use the updated version of the enclave software code to create a new image file for an updated version of the secrets service enclave 250. The software code deployer 225 may determine a unique identifier of the updated version of the secrets service enclave 250. For instance, the software code deployer 225 may determine a hash value (e.g., PCR0) of the image file of the updated version of the secrets service enclave 250.

The secrets service operator 285 may further control a configuration updater 230 of the secrets management system 280 to modify configuration data associated with the secrets management system 280. For instance, the secrets management system 280 may maintain a configuration that includes an identifier associated with a current version of the enclave software code (e.g., a hash of an image file associated with a currently running version of the secrets service enclave 250) and an identifier associated with a previous version of the enclave software code (e.g., a hash of an image file associated with a previous version of the secrets service enclave 250). The configuration updater 230 may update the configuration to replace the identifier associated with the previous version of the enclave software code with the identifier associated with the currently running version of the enclave software code (e.g., a hash of an image file associated with a currently running version of the secrets service enclave 250). The configuration updater 230 may further update the configuration to replace the identifier associated with the currently running version of the enclave software code with an identifier associated with the updated version of the enclave software code (e.g., a hash of an image file associated with the updated version of the secrets service enclave 250), as shown below in Table 1.

TABLE 1

| Enclave Software | Original Identification | Updated Identification |
|---|---|---|
| Code Version | Values | Values |
| Previous version | 0x1abcdef2abcde | 3abcdef4abcdef5 |
| Current version | 3abcdef4abcdef5 | 9abcdef8abcdef7 |

After updating the configuration, the secrets service operator 285 may control the software code deployer 225 to cause the updated version of the enclave software code and corresponding updated secrets service enclave 250 to be deployed to one or more nodes associated with the secrets management service 180. For instance, deploying the updated version of the enclave software code and corresponding updated secrets service enclave 250 may involve downloading and installing the image file associated with the updated secrets service enclave 250 on one or more nodes associated with the secrets management service 180. Deploying the updated version of the enclave software code and corresponding updated secrets service enclave 250 may further involve terminating the previous version of the secrets service enclave 250, and the starting the updated secrets service enclave 250. The secrets service API 245 may further be updated to point to the updated secrets service enclave 250 and restarted to pick up the updated configuration. In some cases, a rolling deployment may be employed in which the updated secrets service enclave 250 may be deployed to a subset of a set of nodes at a time. For instance, the deployment may occur for a first subset of nodes at a first period of time and at a second subset of nodes at a second period of time. In such cases, some of the nodes may be utilizing the updated secrets service enclave 250, while other nodes may be utilizing the previous version of the secrets service enclave 250. Accordingly, it may be necessary to update one or more key policies to indicate that both the updated and previous versions of the enclave software code are authorized to access the managed keys.

Accordingly, the updated configuration may be used to update one or more key policies.

The secrets service operator 285 may further control the key policy updater 235 of the secrets management system 280 to create a new key policy or modify or update an existing key policy using the information in the updated configuration. The new or updated key policy may include an indication of the updated identifier for the previous version of the enclave software code (e.g., which is associated with the currently running version of the enclave software code to be replaced with the updated enclave software) and an indication of the updated identifier for the current version of the enclave software code (e.g., which is associated with the updated version of the enclave software which is to-be deployed). For instance, when a new tenant is onboarded, a new managed key and associated key policy may be created. The new key policy may indicate that encryption and decryption operations using the new managed key may be performed with both the currently running version of the enclave software and the updated version of the enclave software based on the indications of the identifiers associated with the currently running version of the enclave software and the to-be deployed updated version of the enclave software. Further, for existing tenants, the updated key policy (e.g., including the identifiers associated with the currently running version of the enclave software and the to-be deployed updated version of the enclave software) may be associated with or applied to one or more managed keys associated with the existing tenants that utilize the secrets management system 280. For instance, the key policy updater 235 may identify, from among a plurality of managed keys, those managed keys that may be tagged as being associated with the secrets management system 280. The key policy updater 235 may associate or apply the updated key policy to each of the identified managed keys associated with the secrets management system 280.

The secrets service operator 285 may further control the KMS API updater 240 of the secrets management system 280 to update the key management API 260 to utilize the updated key policy (e.g., including the identifiers associated with the currently running version of the enclave software and the to-be deployed updated version of the enclave software). In this way, the key management API 260 may be able to attest and verify the entities of both the current and to-be deployed versions of the enclave software code and corresponding secrets service enclaves 250, and both versions of the enclave software code may be able to make calls to access the managed keys associated with the updated key policy.

In some cases, after successfully deploying the updated version of the secrets service enclave or after a predetermined period of time, the current version of the secrets service enclave 250 may be terminated and in some cases, the key policy may be updated to remove references to the terminated secrets service enclave 250.

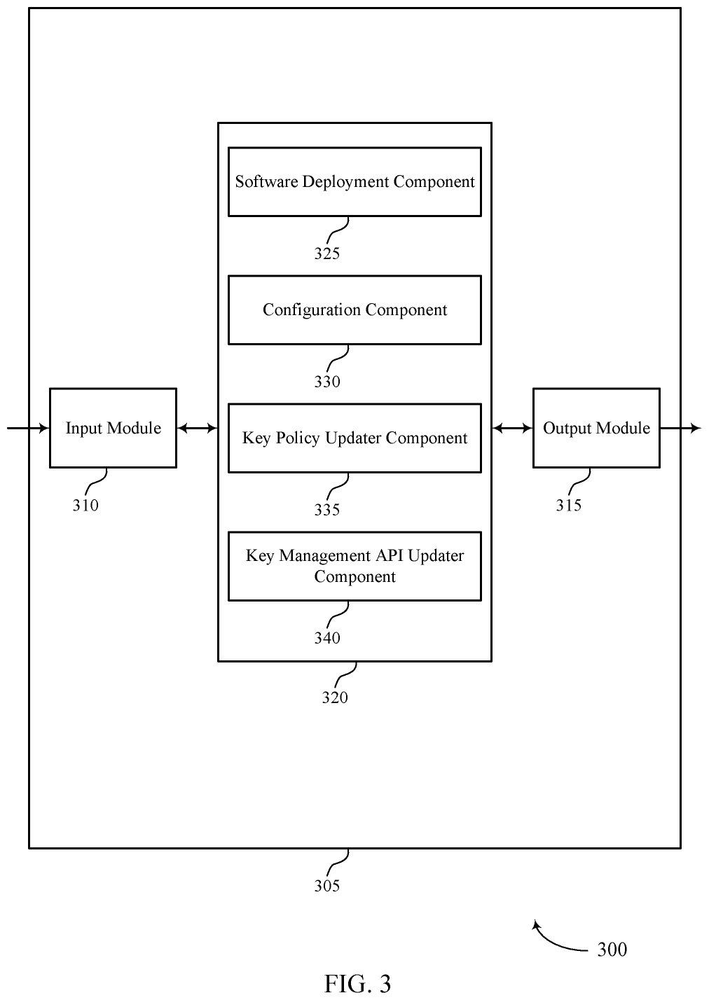

FIG. 3 shows a block diagram 300 of a device 305 that supports automatic software upgrading in secure enclaves for tenant-specific encryption workloads in accordance with aspects of the present disclosure. The device 305 may include an input module 310, an output module 315, and a software module 320. The device 305, or one or more components of the device 305 (e.g., the input module 310, the output module 315, and the software module 320), may include at least one processor, which may be coupled with at least one memory, to support the described techniques. Each of these components may be in communication with one another (e.g., via one or more buses).

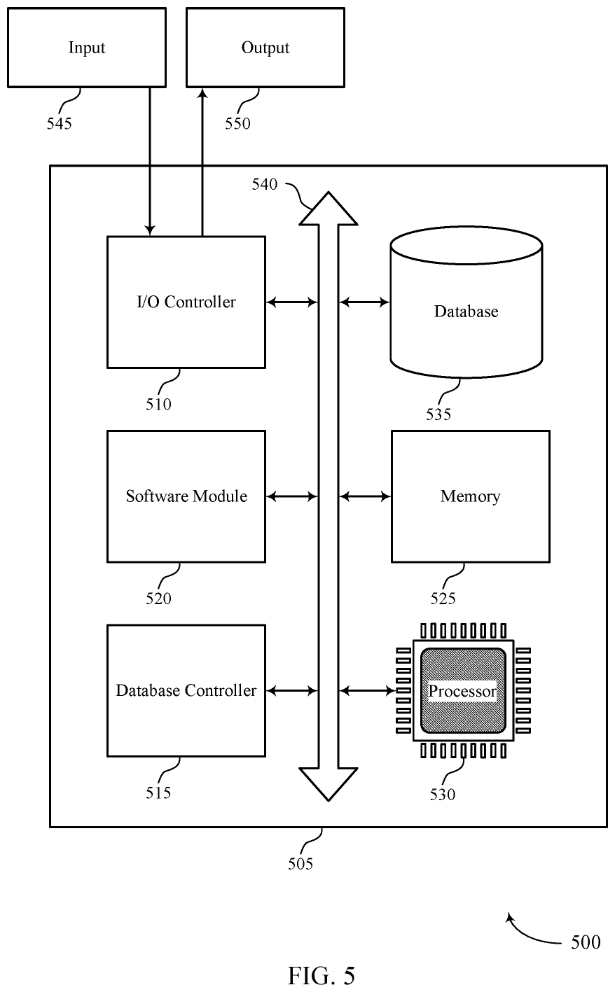

The input module 310 may manage input signals for the device 305. For example, the input module 310 may identify input signals based on an interaction with a modem, a keyboard, a mouse, a touchscreen, or a similar device. These input signals may be associated with user input or processing at other components or devices. In some cases, the input module 310 may utilize an operating system such as iOS®, ANDROID®, MS-DOS®, MS-WINDOWS®, OS/2®, UNIX®, LINUX®, or another known operating system to handle input signals. The input module 310 may send aspects of these input signals to other components of the device 305 for processing. For example, the input module 310 may transmit input signals to the software module 320 to support automatic software upgrading in secure enclaves for tenant-specific encryption workloads. In some cases, the input module 310 may be a component of an input/output (I/O) controller 510 as described with reference to FIG. 5.

The output module 315 may manage output signals for the device 305. For example, the output module 315 may receive signals from other components of the device 305, such as the software module 320, and may transmit these signals to other components or devices. In some examples, the output module 315 may transmit output signals for display in a user interface, for storage in a database or data store, for further processing at a server or server cluster, or for any other processes at any number of devices or systems. In some cases, the output module 315 may be a component of an I/O controller 510 as described with reference to FIG. 5.

For example, the software module 320 may include a software deployment component 325, a configuration component 330, a key policy updater component 335, a key management access point (API) updater component 340, a or any combination thereof. In some examples, the software module 320, or various components thereof, may be configured to perform various operations (e.g., receiving, monitoring, transmitting) using or otherwise in cooperation with the input module 310, the output module 315, or both. For example, the software module 320 may receive information from the input module 310, send information to the output module 315, or be integrated in combination with the input module 310, the output module 315, or both to receive information, transmit information, or perform various other operations as described herein.

The software module 320 may support updating software code in a multi-tenant system in accordance with examples as disclosed herein. The software deployment component 325 may be configured to support receiving an indication that an updated version of software code to be executed in an isolated execution environment is available for deployment. The software deployment component 325 may be configured to support determining a unique identifier associated with the updated version of the software code. The configuration component 330 may be configured to support modifying configuration data including a first identifier associated with a current version of the software code and a second identifier associated with a previous version of the software code, where the modifying includes updating the second identifier with the first identifier and updating the first identifier with the unique identifier associated with the updated version of the software code. The key policy updater component 335 may be configured to support generating, based on the configuration data, an updated key policy, where the updated key policy includes the updated first identifier and the updated second identifier. The key management API updater component 340 may be configured to support updating a key management API by applying the updated key policy to one or more managed keys, where the updated key management API enables the current version of the software code and the updated version of the software code to access the one or more managed keys. The software deployment component 325 may be further configured to support causing deployment of the updated version of the software code to one or more nodes of the multi-tenant system.

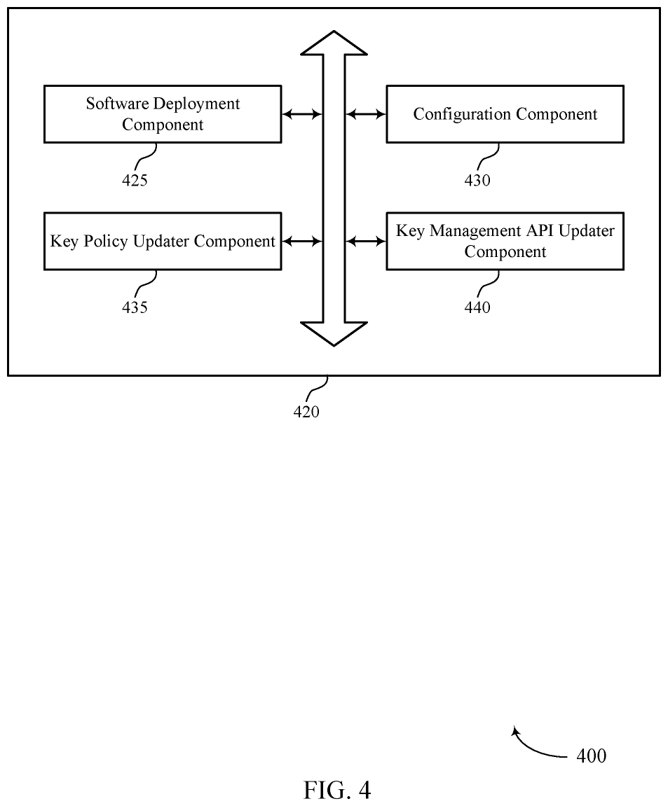

FIG. 4 shows a block diagram 400 of a software module 420 that supports automatic software upgrading in secure enclaves for tenant-specific encryption workloads in accordance with aspects of the present disclosure. The software module 420 may be an example of aspects of a software module or a software module 320, or both, as described herein. The software module 420, or various components thereof, may be an example of means for performing various aspects of automatic software upgrading in secure enclaves for tenant-specific encryption workloads as described herein. For example, the software module 420 may include a software deployment component 425, a configuration component 430, a key policy updater component 435, a key management API updater component 440, or any combination thereof. Each of these components, or components of subcomponents thereof (e.g., one or more processors, one or more memories), may communicate, directly or indirectly, with one another (e.g., via one or more buses).

The software module 420 may support updating software code in a multi-tenant system in accordance with examples as disclosed herein. The software deployment component 425 may be configured to support receiving an indication that an updated version of software code to be executed in an isolated execution environment is available for deployment. In some examples, the software deployment component 425 may be configured to support determining a unique identifier associated with the updated version of the software code. The configuration component 430 may be configured to support modifying configuration data including a first identifier associated with a current version of the software code and a second identifier associated with a previous version of the software code, where the modifying includes updating the second identifier with the first identifier and updating the first identifier with the unique identifier associated with the updated version of the software code. The key policy updater component 435 may be configured to support generating, based on the configuration data, an updated key policy, where the updated key policy includes the updated first identifier and the updated second identifier. The key management API updater component 440 may be configured to support updating a key management API by applying the updated key policy to one or more managed keys, where the updated key management API enables the current version of the software code and the updated version of the software code to access the one or more managed keys. The software deployment component 425 may be further configured to support causing deployment of the updated version of the software code to one or more nodes of the multi-tenant system.

In some examples, the unique identifier associated with the updated version of the software code includes a hash value associated with the isolated execution environment.

In some examples, the hash value includes a hash of an image file of the isolated execution environment.

In some examples, the isolated execution environment includes a virtual machine. In some examples, the virtual machine includes one or more of a kernel, a central processing unit (CPU), and memory.

In some examples, to support updating the key management API, the key management API updater component 440 may be configured to support determining the one or more managed keys based on identifying, from among a set of multiple managed keys, at least one managed key associated with the multi-tenant system.

In some examples, the first identifier associated with the current version of the software code includes a first hash value associated with a first isolated execution environment associated with the current version of the software code. In some examples, the second identifier associated with the previous version of the software code includes a second hash value associated with a second isolated execution environment associated with the previous version of the software code.

In some examples, each of the one or more managed keys is associated with a different tenant associated with the multi-tenant system.

FIG. 5 shows a diagram of a system 500 including a device 505 that supports automatic software upgrading in secure enclaves for tenant-specific encryption workloads in accordance with aspects of the present disclosure. The device 505 may be an example of or include the components of a device 305 as described herein. The device 505 may include components for bi-directional voice and data communications including components for transmitting and receiving communications, such as a software module 520, an I/O controller 510, a database controller 515, at least one memory 525, at least one processor 530, and a database 535. These components may be in electronic communication or otherwise coupled (e.g., operatively, communicatively, functionally, electronically, electrically) via one or more buses (e.g., a bus 540).

The I/O controller 510 may manage input signals 545 and output signals 550 for the device 505. The I/O controller 510 may also manage peripherals not integrated into the device 505. In some cases, the I/O controller 510 may represent a physical connection or port to an external peripheral. In some cases, the I/O controller 510 may utilize an operating system such as iOS®, ANDROID®, MS-DOS®, MS-WINDOWS®, OS/2®, UNIX®, LINUX®, or another known operating system. In other cases, the I/O controller 510 may represent or interact with a modem, a keyboard, a mouse, a touchscreen, or a similar device. In some cases, the I/O controller 510 may be implemented as part of a processor 530. In some examples, a user may interact with the device 505 via the I/O controller 510 or via hardware components controlled by the I/O controller 510.

The database controller 515 may manage data storage and processing in a database 535. In some cases, a user may interact with the database controller 515. In other cases, the database controller 515 may operate automatically without user interaction. The database 535 may be an example of a single database, a distributed database, multiple distributed databases, a data store, a data lake, or an emergency backup database.

Memory 525 may include random-access memory (RAM) and read-only memory (ROM). The memory 525 may store computer-readable, computer-executable software including instructions that, when executed, cause at least one processor 530 to perform various functions described herein. In some cases, the memory 525 may contain, among other things, a basic I/O system (BIOS) which may control basic hardware or software operation such as the interaction with peripheral components or devices. The memory 525 may be an example of a single memory or multiple memories. For example, the device 505 may include one or more memories 525.

The processor 530 may include an intelligent hardware device (e.g., a general-purpose processor, a digital signal processor (DSP), a CPU, a microcontroller, an application-specific integrated circuit (ASIC), a field-programmable gate array (FPGA), a programmable logic device, a discrete gate or transistor logic component, a discrete hardware component, or any combination thereof). In some cases, the processor 530 may be configured to operate a memory array using a memory controller. In other cases, a memory controller may be integrated into the processor 530. The processor 530 may be configured to execute computer-readable instructions stored in at least one memory 525 to perform various functions (e.g., functions or tasks supporting automatic software upgrading in secure enclaves for tenant-specific encryption workloads). The processor 530 may be an example of a single processor or multiple processors. For example, the device 505 may include one or more processors 530.

The software module 520 may support updating software code in a multi-tenant system in accordance with examples as disclosed herein. For example, the software module 520 may be configured to support receiving an indication that an updated version of software code to be executed in an isolated execution environment is available for deployment. The software module 520 may be configured to support determining a unique identifier associated with the updated version of the software code. The software module 520 may be configured to support modifying configuration data including a first identifier associated with a current version of the software code and a second identifier associated with a previous version of the software code, where the modifying includes updating the second identifier with the first identifier and updating the first identifier with the unique identifier associated with the updated version of the software code. The software module 520 may be configured to support generating, based on the configuration data, an updated key policy, where the updated key policy includes the updated first identifier and the updated second identifier. The software module 520 may be configured to support updating a key management API by applying the updated key policy to one or more managed keys, where the updated key management API enables the current version of the software code and the updated version of the software code to access the one or more managed keys. The software module 520 may be configured to support causing deployment of the updated version of the software code to one or more nodes of the multi-tenant system.

By including or configuring the software module 520 in accordance with examples as described herein, the device 505 may support techniques for improved user experience related to automated processing and reduced production downtime.

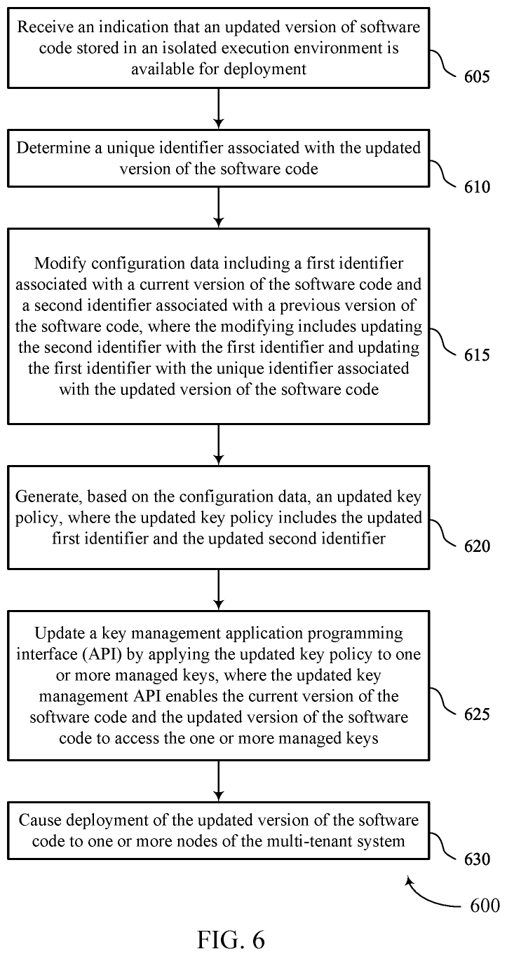

FIG. 6 shows a flowchart illustrating a method 600 that supports automatic software upgrading in secure enclaves for tenant-specific encryption workloads in accordance with aspects of the present disclosure. The operations of the method 600 may be implemented by a secrets service system or its components as described herein. For example, the operations of the method 600 may be performed by a secrets service system as described with reference to FIGS. 1 through 5. In some examples, a secrets service system may execute a set of instructions to control the functional elements of the secrets service system to perform the described functions. Additionally, or alternatively, the secrets service system may perform aspects of the described functions using special-purpose hardware.

At 605, the method may include receiving an indication that an updated version of software code to be executed in an isolated execution environment is available for deployment. The operations of block 605 may be performed in accordance with examples as disclosed herein. In some examples, aspects of the operations of 605 may be performed by a software deployment component 425 as described with reference to FIG. 4.

At 610, the method may include determining a unique identifier associated with the updated version of the software code. The operations of block 610 may be performed in accordance with examples as disclosed herein. In some examples, aspects of the operations of 610 may be performed by a software deployment component 425 as described with reference to FIG. 4.

At 615, the method may include modifying configuration data including a first identifier associated with a current version of the software code and a second identifier associated with a previous version of the software code, where the modifying includes updating the second identifier with the first identifier and updating the first identifier with the unique identifier associated with the updated version of the software code. The operations of block 615 may be performed in accordance with examples as disclosed herein. In some examples, aspects of the operations of 615 may be performed by a configuration component 430 as described with reference to FIG. 4.

At 620, the method may include generating, based on the configuration data, an updated key policy, where the updated key policy includes the updated first identifier and the updated second identifier. The operations of block 620 may be performed in accordance with examples as disclosed herein. In some examples, aspects of the operations of 620 may be performed by a key policy updater component 435 as described with reference to FIG. 4.

At 625, the method may include updating a key management API to apply the updated key policy to one or more managed keys, where the updated key management API enables the current version of the software code and the updated version of the software code to access the one or more managed keys. The operations of block 625 may be performed in accordance with examples as disclosed herein. In some examples, aspects of the operations of 625 may be performed by a key management API updater component 440 as described with reference to FIG. 4.

At 630, the method may include causing deployment of the updated version of the software code to one or more nodes of the multi-tenant system. The operations of block 630 may be performed in accordance with examples as disclosed herein. In some examples, aspects of the operations of 630 may be performed by a software deployment component 425 as described with reference to FIG. 4.

The following provides an overview of aspects of the present disclosure:

Aspect 1: A computer-implemented method for updating software code in a multi-tenant system, comprising: receiving an indication that an updated version of software code to be executed in an isolated execution environment is available for deployment; determining a unique identifier associated with the updated version of the software code; modifying configuration data comprising a first identifier associated with a current version of the software code and a second identifier associated with a previous version of the software code, wherein the modifying comprises updating the second identifier with the first identifier and updating the first identifier with the unique identifier associated with the updated version of the software code; generating, based at least in part on the configuration data, an updated key policy, wherein the updated key policy comprises the updated first identifier and the updated second identifier; updating a key management API by applying the updated key policy to one or more managed keys, wherein the updated key management API enables the current version of the software code and the updated version of the software code to access the one or more managed keys; and causing deployment of the updated version of the software code to one or more nodes of the multi-tenant system.

Aspect 2: The computer-implemented method of aspect 1, wherein the unique identifier associated with the updated version of the software code comprises a hash value associated with the isolated execution environment.

Aspect 3: The computer-implemented method of aspect 2, wherein the hash value comprises a hash of an image file of the isolated execution environment.

Aspect 4: The computer-implemented method of any of aspects 1 through 3, wherein the isolated execution environment comprises a virtual machine, and the virtual machine comprises one or more of a kernel, a CPU, and memory.

Aspect 5: The computer-implemented method of any of aspects 1 through 4, wherein updating the key management API comprises: determining the one or more managed keys based at least in part on identifying, from among a plurality of managed keys, at least one managed key associated with the multi-tenant system.

Aspect 6: The computer-implemented method of any of aspects 1 through 5, wherein the first identifier associated with the current version of the software code comprises a first hash value associated with a first isolated execution environment associated with the current version of the software code, and the second identifier associated with the previous version of the software code comprises a second hash value associated with a second isolated execution environment associated with the previous version of the software code.

Aspect 7: The computer-implemented method of any of aspects 1 through 6, wherein each of the one or more managed keys is associated with a different tenant associated with the multi-tenant system.

Aspect 8: An apparatus for updating software code in a multi-tenant system, comprising one or more memories storing processor-executable code, and one or more processors coupled with the one or more memories and individually or collectively operable to execute the code to cause the apparatus to perform a method of any of aspects 1 through 7.

Aspect 9: An apparatus for updating software code in a multi-tenant system, comprising at least one means for performing a method of any of aspects 1 through 7.

Aspect 10: A non-transitory computer-readable medium storing code for updating software code in a multi-tenant system, the code comprising instructions executable by one or more processors to perform a method of any of aspects 1 through 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable ROM (EEPROM), compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A computer-implemented method for updating software code in a multi-tenant system, comprising:
receiving an indication that an updated version of software code to be executed in an isolated execution environment is available for deployment;
determining a unique identifier associated with the updated version of the software code;
modifying configuration data comprising a first identifier associated with a current version of the software code and a second identifier associated with a previous version of the software code, wherein the modifying comprises updating the second identifier with the first identifier and updating the first identifier with the unique identifier associated with the updated version of the software code;
generating, based at least in part on the configuration data, an updated key policy, wherein the updated key policy comprises the updated first identifier and the updated second identifier;
updating a key management application programming interface (API) by applying the updated key policy to one or more managed keys, wherein the updated key management API enables the current version of the software code and the updated version of the software code to access the one or more managed keys; and
causing deployment of the updated version of the software code to one or more nodes of the multi-tenant system.

2. The computer-implemented method of claim 1, wherein the unique identifier associated with the updated version of the software code comprises a hash value associated with the isolated execution environment.

3. The computer-implemented method of claim 2, wherein the hash value comprises a hash of an image file of an image file of the isolated execution environment.

4. The computer-implemented method of claim 1, wherein:
the isolated execution environment comprises a virtual machine, and
the virtual machine comprises one or more of a kernel, a central processing unit (CPU), and memory.

5. The computer-implemented method of claim 1, wherein updating the key management API comprises:
determining the one or more managed keys based at least in part on identifying, from among a plurality of managed keys, at least one managed key associated with the multi-tenant system.

6. The computer-implemented method of claim 1, wherein:
the first identifier associated with the current version of the software code comprises a first hash value associated with a first isolated execution environment associated with the current version of the software code, and
the second identifier associated with the previous version of the software code comprises a second hash value associated with a second isolated execution environment associated with the previous version of the software code.

7. The computer-implemented method of claim 1, wherein each of the one or more managed keys is associated with a different tenant associated with the multi-tenant system.

8. An apparatus for updating software code in a multi-tenant system, comprising:
one or more memories storing processor-executable code; and
one or more processors coupled with the one or more memories and individually or collectively operable to execute the code to cause the apparatus to:
receive an indication that an updated version of software code to be executed in an isolated execution environment is available for deployment;
determine a unique identifier associated with the updated version of the software code;
modify configuration data comprising a first identifier associated with a current version of the software code and a second identifier associated with a previous version of the software code, wherein the modifying comprises updating the second identifier with the first identifier and updating the first identifier with the unique identifier associated with the updated version of the software code;
generate, based at least in part on the configuration data, an updated key policy, wherein the updated key policy comprises the updated first identifier and the updated second identifier;
update a key management application programming interface (API) to apply the updated key policy to one or more managed keys, wherein the updated key management API enables the current version of the software code and the updated version of the software code to access the one or more managed keys; and
cause deployment of the updated version of the software code to one or more nodes of the multi-tenant system.

9. The apparatus of claim 8, wherein the unique identifier associated with the updated version of the software code comprises a hash value associated with the isolated execution environment.

10. The apparatus of claim 9, wherein the hash value comprises a hash of an image file of the isolated execution environment.

11. The apparatus of claim 8, wherein:
the isolated execution environment comprises a virtual machine, and
the virtual machine comprises one or more of a kernel, a central processing unit (CPU), and memory.

12. The apparatus of claim 8, wherein, to update the key management API, the one or more processors are individually or collectively operable to execute the code to cause the apparatus to:
determine the one or more managed keys based at least in part on identifying, from among a plurality of managed keys, at least one managed key associated with the multi-tenant system.

13. The apparatus of claim 8, wherein:
the first identifier associated with the current version of the software code comprises a first hash value associated with a first isolated execution environment associated with the current version of the software code, and
the second identifier associated with the previous version of the software code comprises a second hash value associated with a second isolated execution environment associated with the previous version of the software code.

14. The apparatus of claim 8, wherein each of the one or more managed keys is associated with a different tenant associated with the multi-tenant system.

15. A non-transitory computer-readable medium storing code for updating software code in a multi-tenant system, the code comprising instructions executable by one or more processors to:
receive an indication that an updated version of software code to be executed in an isolated execution environment is available for deployment;
determine a unique identifier associated with the updated version of the software code;
modify configuration data comprising a first identifier associated with a current version of the software code and a second identifier associated with a previous version of the software code, wherein the modifying comprises updating the second identifier with the first identifier and updating the first identifier with the unique identifier associated with the updated version of the software code;
generate, based at least in part on the configuration data, an updated key policy, wherein the updated key policy comprises the updated first identifier and the updated second identifier;
update a key management application programming interface (API) by applying the updated key policy to one or more managed keys, wherein the updated key management API enables the current version of the software code and the updated version of the software code to access the one or more managed keys; and
cause deployment of the updated version of the software code to one or more nodes of the multi-tenant system.

16. The non-transitory computer-readable medium of claim 15, wherein the unique identifier associated with the updated version of the software code comprises a hash value associated with the isolated execution environment, wherein the hash value comprises a hash of an image file of the isolated execution environment.

17. The non-transitory computer-readable medium of claim 15, wherein:
the isolated execution environment comprises a virtual machine, and
the virtual machine comprises one or more of a kernel, a central processing unit (CPU), and memory.

18. The non-transitory computer-readable medium of claim 15, wherein the instructions to update the key management API are executable by the one or more processors to:
determine the one or more managed keys based at least in part on identifying, from among a plurality of managed keys, at least one managed key associated with the multi-tenant system.

19. The non-transitory computer-readable medium of claim 15, wherein:
the first identifier associated with the current version of the software code comprises a first hash value associated with a first isolated execution environment associated with the current version of the software code, and
the second identifier associated with the previous version of the software code comprises a second hash value associated with a second isolated execution environment associated with the previous version of the software code.

20. The non-transitory computer-readable medium of claim 15, wherein each of the one or more managed keys is associated with a different tenant associated with the multi-tenant system.
